(19) United States
(12) Patent Application Publication
(10) Pub. No.: US 2025/0174018 A1
(43) Pub. Date: May 29, 2025

(54) METHOD AND SYSTEM FOR SMALL OBJECT DETECTION IN IMAGES USING MACHINE LEARNING AND SIGNAL PROCESSING TECHNIQUES

(71) Applicant: Hamad Bin Khalifa University (HBKU), Doha (QA)

(72) Inventors: Mohammad Amin Sadeghi, Doha (QA); Sanjay Chawla, Doha (QA)

(21) Appl. No.: 18/962,576

(22) Filed: Nov. 27, 2024

Related U.S. Application Data
(60) Provisional application No. 63/604,031, filed on Nov. 29, 2023.

(51) Int. Cl. G06V 10/82; G06V 10/764

(52) U.S. Cl. CPC G06V 10/82; G06V 10/764

(57) ABSTRACT

Example systems, methods, and apparatus are disclosed herein for a method and system for small object detection in images using machine learning and signal processing techniques.

### PRIORITY CLAIM AND CROSS-REFERENCE TO RELATED APPLICATIONS

The present application claims the benefit of U.S. Provisional Application No. 63/604,031 filed Nov. 29, 2023, which is incorporated herein by reference in its entirety.

### BACKGROUND

The present disclosure relates to the field of computer vision and image processing, specifically addressing the challenge of detecting small objects in images. Small object detection is a critical task in various applications, including but not limited to autonomous vehicles, surveillance systems, medical imaging, flight safety and industrial automation. Existing methods often struggle with accurately detecting small objects due to factors such as limited resolution, occlusions, and noise in the input images.

Therefore, there is a need for a method of small object detection that uses machine learning and signal processing and that is accurate and fast.

### SUMMARY

Example systems, methods, and apparatus are disclosed herein for a method and system for small object detection in images using machine learning and signal processing techniques.

In light of the disclosure herein, and without limiting the scope of the invention in any way, in a first aspect of the present disclosure, which may be combined with any other aspect listed herein unless specified otherwise, a system for small object detection in images using machine learning and signal processing techniques.

In a second aspect of the present disclosure, which may be combined with any other aspect listed herein unless specified otherwise, a method of using a system for small object detection in images using machine learning and signal processing techniques.

In light of the present disclosure and the above aspects, it is therefore an advantage of the present disclosure to provide users with a method and system for small object detection in images using machine learning and signal processing techniques.

Additional features and advantages are described in, and will be apparent from, the following Detailed Description. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### DETAILED DESCRIPTION

Methods, systems, and apparatus are disclosed herein for small object detection in images using machine learning and signal processing techniques.

While the example methods, apparatus, and systems are disclosed herein for small object detection in images using machine learning and signal processing techniques, it should be appreciated that the methods, apparatus, and systems may be operable for other applications.

The disclosed technology proposes a novel approach that combines machine learning techniques and signal processing methods to enhance the accuracy and efficiency of small object detection in images. This method significantly improves the ability to identify and locate small objects within complex scenes, making it valuable for a wide range of real-world applications.

The disclosed technology comprises a small object detection system that comprises a computer, a memory, and a processor. The system includes a preprocessing module, an image alignment module, a feature extraction module, a machine learning classifier module, a signal processing refinement module, and a post-processing module. Notably the aforementioned modules are stored in the memory. The processor is able to communicate with the memory to access the modules and apply their respective functions.

The first step is the preprocessing module. In the preprocessing module, an input image undergoes preprocessing to enhance its quality and reduce noise. In some embodiments, this step may involve techniques like image denoising, contrast enhancement, and image resizing to optimize subsequent processing steps.

The next step is an image alignment module. The image alignment module addresses the challenges posed by image misalignment. This module aligns the input images, compensating for translation, rotation, and scale variations. Image alignment ensures that small objects are consistently positioned in the same coordinate frame, improving detection accuracy.

After the image alignment module there is a feature extraction module. In the feature extraction module, aligned images processed to extract discriminative features from the preprocessed image. Convolutional Neural Networks (CNNs) are employed to capture relevant spatial and contextual information from the image.

After this, the extracted features are fed to a machine learning classifier. The machine learning classifier is trained on a diverse dataset of images containing small objects. The classifier in the disclosed technology employs state-of-the-art deep learning architectures to effectively discriminate between small objects and background clutter.

After this, to further improve detection accuracy, a signal processing refinement module is introduced. This phase leverages various signal processing techniques such as morphological operations, edge detection, and thresholding to enhance object boundaries and reduce false positives.

Finally, there is a post-processing module. Detected object candidates are subjected to post-processing to eliminate duplicate detections and refine the final object detection results. Non-maximum suppression and geometric constraints are applied to ensure robust and accurate localization.

Computation time is a critical aspect of the disclosed technology. In applications such as autonomous vehicles and real-time surveillance, timely detection of small objects is paramount. The method in the disclosed technology is designed for efficient real-time processing, ensuring that small objects can be detected and responded to in a timely manner. The integration of machine learning, signal processing, and image alignment techniques optimizes the computation time, making the system in the disclosed technology suitable for high-speed and low-latency environments.

High Accuracy: the method in the disclosed technology significantly improves small object detection accuracy, even in challenging scenarios.

Real-time Capability: The combination of machine learning, signal processing, and image alignment techniques enables efficient real-time processing for applications requiring rapid detection.

Versatility: The disclosed technology is versatile and can be applied to various domains, including but not limited to computer vision, medical imaging, and industrial automation.

The disclosed technology presents a unique and effective solution to the challenging problem of small object detection in images. By combining advanced machine learning techniques with signal processing refinement, the method in the disclosed technology achieves superior accuracy and robustness in detecting small objects across diverse applications. We believe that this innovation has the potential to advance the state of the art in small object detection, and we look forward to further development and commercialization opportunities.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system for small object detection in images using machine learning and signal processing techniques, the system comprising:
a computer,
a processor, and
a memory storing instructions, which when executed by processor, cause the processor to apply a set of machine learning and signal processing techniques, wherein the computer is configured to receive an input image and transmit the input image to the processor.

2. The system of claim 1, wherein the set of machine learning and signal processing techniques comprises a preprocessing module, an image alignment module, a feature extraction module, a machine learning classifier module, a signal processing refinement module, and a post-processing module.

3. The system of claim 2, wherein the preprocessing module comprises at least one of image denoising, contrast enhancement, or image resizing.

4. The system of claim 2, wherein the preprocessing module comprises preprocessing the input image to enhance its quality and reduce noise.

5. The system of claim 2, wherein the image alignment module comprises aligning the input image to compensate for translation, rotation, and scale variations.

6. The system of claim 2, wherein the feature extraction module comprises processing an aligned image from the image alignment module to extract discriminative features.

7. The system of claim 6, wherein the feature extraction module employs Convolutional Neural Networks (CNNs) to capture relevant spatial and contextual information from the aligned image.

8. The system of claim 2, wherein the machine learning classifier module comprises discriminating between small objects and background clutter in a feature extracted image from the feature extraction module.

9. The system of claim 8, wherein the machine learning classifier module comprises a machine learning classifier that is trained on a diverse dataset of images containing small objects and employs deep learning architectures to discriminate between small objects and background clutter.

10. The system of claim 2, wherein the signal processing refinement module comprises using at least one of morphological operations, edge detection, and thresholding to enhance object boundaries and reduce false positives on an image from the machine learning classifier module.

11. The system of claim 2, wherein the post-processing module comprises eliminating duplicate detections and refining final object detections from an image from the signal processing refinement module, and wherein the post-processing module comprises applying non-maximum suppression and geometric constraints to the image from the signal processing refinement module.

12. A method for using a system for small object detection in images using machine learning and signal processing techniques, the method comprising:
receiving an input image,
applying a preprocessing module to the input image to result in a preprocessed image,
applying an image alignment module to the preprocessed image to result in an aligned image,
applying a feature extraction module to the aligned image to result in an extracted image,
applying a machine learning classifier module to the extracted image to result in a classified image,
applying a signal processing refinement module to the classified image to result in a refined image, and
applying a post-processing module to the refined image to result in a final image.

13. The method of claim 12, wherein the preprocessing module comprises preprocessing the input image to enhance its quality and reduce noise, and wherein the preprocessing module comprises at least one of image denoising, contrast enhancement, or image resizing.

14. The method of claim 12, wherein the image alignment module comprises aligning the preprocessed image to compensate for translation, rotation, and scale variations.

15. The method of claim 12, wherein the feature extraction module comprises processing the aligned image to extract discriminative features, and wherein the feature extraction module employs Convolutional Neural Networks (CNNs) to capture relevant spatial and contextual information from the aligned image.

16. The method of claim 12, wherein the machine learning classifier module comprises discriminating between small objects and background clutter in the extracted image.

17. The method of claim 12, wherein the machine learning classifier module comprises a machine learning classifier that is trained on a diverse dataset of images containing small objects and employs deep learning architectures to discriminate between small objects and background clutter.

18. The method of claim 12, wherein the signal processing refinement module comprises using at least one of morphological operations, edge detection, and thresholding to enhance object boundaries and reduce false positives on the classified image.

19. The method of claim 12, wherein the post-processing module comprises eliminating duplicate detections and refining final object detections from the refined image.

20. The method of claim 12, wherein the post-processing module comprises applying non-maximum suppression and geometric constraints to the refined image.
